(19) United States
(12) Patent Application Publication
(10) Pub. No.: US 2014/0067699 A1
(43) Pub. Date: Mar. 6, 2014

(54) SYSTEM, METHOD AND COMPUTER SOFTWARE CODE FOR AUTHENTICATION OF AN ITEM

(71) Applicant: Gennady Volchek, Melbourne (AU)

(72) Inventor: Gennady Volchek, Melbourne (AU)

(21) Appl. No.: 13/880,176

(22) PCT Filed: Sep. 26, 2011
(86) PCT No.: PCT/AU2011/001231

§ 371 Date: Nov. 19, 2013

(30) Foreign Application Priority Data
Sep. 24, 2010 (AU) 2010904322

(51) Int. Cl. G06Q 30/00

(52) U.S. Cl. CPC G06Q 30/018
USPC 705/317

(57) ABSTRACT

A system for assisting with the determination of the authenticity of an item which system includes a plurality of databases having stored therein information associated with authentic items available for purchase and a user interface module operable by a customer and configured to receive an indicia from a customer viewing an available item for purchase. The indicia is disposed on, or associated with, the item, and a control module, in communication with the user interface module, is configured to receive the indicia and either, retrieve data from the plurality of databases containing stored information relating to the item, or provide a response indicating the failure to locate stored information corresponding with the supplied indicia, and provide either the failure indication or the retrieved data to the user interface module for presentation. The customer receives either a failure indication or retrieved data from the plurality of databases for comparison.

The present invention relates to a system, method and computer software code for providing information to enable a determination of the authenticity of items such as pharmaceutical products, clothing and/or adornments and or any other products where authenticity is important. In particular, the method, system and computer software code involve one or more indicia disposed on or as part of the item to enable a determination regarding the likelihood that the item is authentic.

### BACKGROUND OF THE INVENTION

A consumer may seek to authenticate items to reduce the risk associated with the purchase of non-authentic items. For example, a consumer seeking to purchase medication or pharmaceuticals is particularly interested in ensuring that they are purchasing authentic pharmaceuticals as non-authentic pharmaceuticals represent a significant health risk. The purchase of some items such as clothing and adornments (for example, a designer original or a feature item worn by a celebrity), is also a significant investment, and a consumer may also seek to authenticate such items.

In any event, when making such an investment a customer may seek assurance that they are purchasing an authentic product and not an imitation item. This is particularly problematic in the online environment where improved mechanisms are required to ensure the authenticity of purchases. On-line purchases are more susceptible to counterfeit goods because a prospective purchaser cannot inspect the product with the same level of scrutiny as with conventional purchases. On-line fraud not only negatively impacts consumer confidence, but also causes financial damage to the manufacturer of the product where goodwill and reputation suffers.

Any discussion of the prior art in this specification is included for the purpose of providing background and should not be interpreted as an admission that such prior art is widely known or forms part of the common general knowledge in the field of the invention.

### SUMMARY OF THE INVENTION

The invention relates to a system, method and device for the authentication of items such as pharmaceutical products, clothing and/or adornments and/or any other items. The invention may provide a measure of likely authenticity of the item or provide a user with information sufficient to make this determination. This is of significant advantage to both potential customers who want a genuine item and to manufacturer's who seek to maintain the goodwill of their brand.

In a first aspect the present invention provides a system for assisting with the determination of the authenticity of an item when a prospective customer views an available item for purchase by providing the customer with information relating to the likely authenticity of the item, the system including a plurality of databases having stored therein information associated with authentic items available for purchase, a user interface module, operable by a customer and configured to receive an indicia from a customer viewing an available item for purchase, wherein the indicia is disposed on, or associated with, the item, and a control module, in communication with the user interface module, configured to receive the unique indicia and either, retrieve data from the plurality of databases containing stored information relating to the item, or provide a response indicating the failure to locate stored information corresponding with the supplied unique indicia; and provide either the failure indication or the retrieved data to the user interface module for presentation to the customer, where the customer receives either a failure indication or retrieved data from the plurality of databases enabling the customer to compare same with the available item for purchase.

According to an embodiment of the first aspect, the user interface module further includes a capture module for capturing the indicia. The user interface module may further include receiving information relating to the item.

According to an embodiment of the first aspect, the control module generates an authenticity score based upon at least a comparison of the information from the user interface module with the information from the plurality of databases. The authenticity score in this embodiment is presented as a colour coded guide. The authenticity score is presented individually for a plurality of comparison points.

In another embodiment, upon receiving the failure indication or the retrieved data, the customer decides whether to proceed with a purchase of the item.

According to an embodiment of the first aspect, the information relating to the item includes at least one of a label, a three dimensional measurement of the item, a fabric or material characteristic, or a packaging characteristic. The material characteristic may include at least one of colour, molecular structure, a fixative type, number of fixatives or the position of a fixative. The fixative type may include one or more of stitching, buttons, zippers, hooks and loop fasteners, drawstrings, clasps and/or buckles.

According to an alternative embodiment of the first aspect, the indicia includes at least one of an alpha-numeric code, a bar code or a data dot. The indicia may be associated with at least one of a serial number; a size; manufacturing data; distribution data; a photographic image of the item; a previous location of the item, or a status of the item. The indicia may be generated from a combination of indicia and/or other information of the item.

According to an embodiment of the first aspect, the control module includes a database that is dynamically updated with history of the item so that the history may be obtained for authentication. The history of the item may include at least one of current and/or prior locations of the item, previous enquiry information, whether the item has previously been sold, a sale date of the item, previous owners of the item, or people who have worn or used the item at notable events.

The control module includes a fraudulent activity detector, wherein access to the stored history of the item is monitored in an attempt to locate potentially fraudulent activity on the part of entities seeking to obtain information regarding the items for the purpose of manufacturing counterfeit copies thereof. The history of the item may include whether the item is, or has been, stolen or may also include information pertaining to recalls or the expiry of authentic goods issues by the manufacturer.

According to an embodiment, the system further includes an interface for receiving information relating to the sale of the item, wherein the history of the item is updated based upon receipt of information relating to sale of the item.

According to an embodiment, the user interface module, the plurality of databases, and the control module are operably connected to a communications network. The control module may be operably connected to one or more databases for the purpose of obtaining additional information regarding the history of an item.

The item may include a pharmaceutical item, clothing, or an adornment.

In a second aspect the present invention provides a method for assisting with the determination of the authenticity of an item when a customer views an available item for purchase by providing the customer with information relating to the likely authenticity of the item, the method including:

the customer obtaining an indicia for the item that is disposed on, or associated with, the item;

querying a plurality of databases to obtain information associated with the unique indicia and receiving a response indicating either the failure to locate stored information corresponding with the supplied indicia or data containing stored information relating to the item; and

the customer comparing the received information with the available item for purchase.

In a third aspect, the present invention provides computer instruction code for assisting with the determination of the authenticity of an item that is viewed by a prospective customer as an available item for purchase by providing the customer with information relating to the likelihood that the item is authentic, including:

computer instruction code to operate a user interface module to obtain an indicia from the item that is disposed on, or associated with, the item;

computer instruction code to transmit the indicia obtained by the user interface module to a control module; and

computer instruction code operable to receive the unique indicia and either, retrieve data from a plurality of databases containing stored information relating to the item, or receive a response indicating the failure to locate stored information corresponding with the unique indicia; and

computer instruction code to present either the failure indication or the retrieved data to the customer thereby enabling the customer to compare same with the item for purchase.

Further features of the present invention will become apparent from the following detailed description.

In this specification, the terms “comprises”, “comprising” or similar terms are intended to mean a non-exclusive inclusion, such that a method, system or apparatus that comprises a list of elements does not include those elements solely, but may well include other elements not listed.

### BRIEF DESCRIPTION OF THE DRAWINGS

In order that the present invention may be readily understood and put into practical effect, reference will now be made to the accompanying illustrations, wherein like reference numerals are used to refer to like elements, and wherein:

FIG. 1 illustrates a system according to one embodiment of the invention;

FIG. 2 illustrates another embodiment of a system according to the invention;

FIG. 3 illustrates yet another embodiment of a system according to the invention; and

FIG. 4 is a diagrammatic representation of a method according to an embodiment of the invention.

### DETAILED DESCRIPTION OF THE INVENTION

The following detailed description of the invention refers to the accompanying drawings. Although the description includes exemplary embodiments, other embodiments are possible, and changes may be made to the embodiments described without departing from the spirit and scope of the invention.

The invention is particularly suitable for use with pharmaceutical products.

The invention is also suitable for use with clothing including shirts, blouses, dresses, skirts, vests, jumpers, jackets, pants, suits, shoes, hats and/or gloves, or adornments such as watches, scarves, bracelets, anklets, necklaces, fascinators or girdles, or any other hems that need to be authenticated.

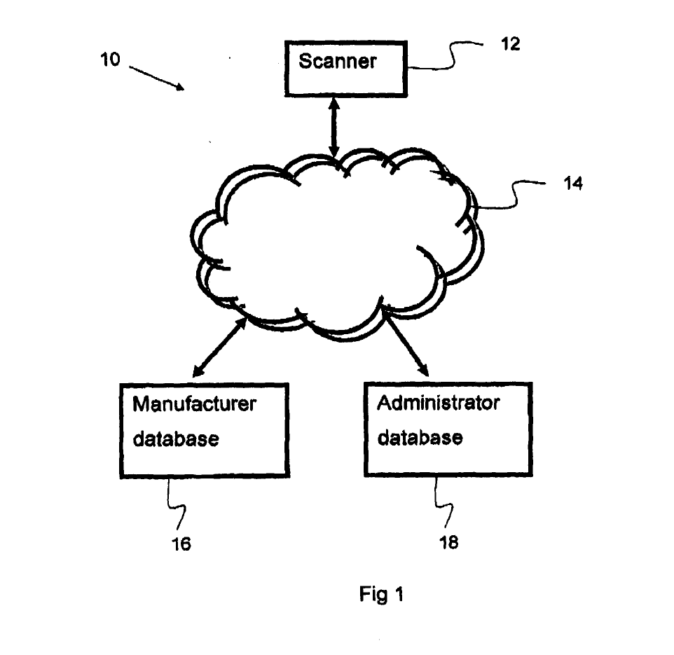

FIG. 1 shows one embodiment of a system 10 according to the invention which includes a computer means in the form of a scanner 12, connected through a communications network 14 to a manufacturer database 16 and an administrator database or control module 18.

The system 10 operates by using scanner 12 to scan an indicia disposed on the item. The scanner is operated by a user interface, in which additional data may be provided. As will be understood by a skilled reader, any suitable means may be used to input the indicia and the additional information to the system. For example, the indicia may be manually input into the user interface by a user.

An indicia is applied to the item by the brand owner, manufacturer, distributer or retailer, or other authorised entity, and is for each item or for a batch of items. The indicia may be part of the item.

The scanned indicia may be used to query a manufacturer's database 16 which stores information associated with the indicia and thereby assisting in a determination regarding the authenticity of the item.

A brand owner or manufacturer may issue a license to sell to an item or group of items identified by an indicia. The license to sell can only be used at the retail or an online store authorised by the manufacturer or other authorised entity. A consumer may then query the manufacturer database in order to determine whether a retail or online store is licensed to sell the product associated with the indicia, and therefore assist in verifying an authenticity of the item.

Because the license to sell is managed by the manufacturer and secured databases located and managed by manufacturer, no other party can tamper with those licenses unlike with the actual products that are not managed by the manufacturer once they have been dispatched.

The administrator database 18 may be dynamically updated with history of the item or items associated with the indicia so that additional information regarding the item and its history may be use to verify the authenticity of the item. The history of the item may include current and/or prior location, sale and/or inquiry history such as, identity and/or location of inquirer, date of the inquiry, whether the item was sold and/or date of sale.

in one embodiment the administrator database 18 may be updated to include the information stored in the manufacturer database 18 associated with a scanned indicia.

The indicia may comprise an alpha numeric code, a bar code and/or a data dot, for example.

When the indicia is a bar code, the bar code may be a conventional two dimensional bar code, for example. When the indicia is an alpha numeric code, the code may include a coded section identifying and to the particular item or items to which the indicia is affixed and an alphabetic section such as a brand identifier to identify the manufacturer of the clothing.

The indicia may be obtained prior to purchase, for example through an image provided to a prospective customer, and verified prior to purchase. Alternatively or additionally, the indicia may be verified on reception of the item.

In the case of the pharmaceutical industry, an indicia may be applied to a batch of pharmaceuticals or to each pharmaceutical individually. A batch of pharmaceuticals may be given an indicia, which May be associated with information about the batch of pharmaceuticals, for example an authorised seller of the batch of pharmaceuticals, such as a pharmacy or pharmacy chain, or a website on which the pharmaceuticals will be sold.

A purchaser of pharmaceuticals may then use the indicia to obtain further information about the pharmaceutical, as described above. The further information may include a name of the company, website, pharmacy or pharmacist authorised to sell the pharmaceutical, an amount of pharmaceutical left in the batch, or any other relevant information. The purchaser may then compare this information with information it has available in order to determined an authenticity of the pharmaceuticals.

For example, a purchaser may compare the authorised website to sell the pharmaceutical with that associated with the indicia. If there is not a match between the authorised website and the website where the pharmaceuticals were purchased, the purchaser may further investigate the authenticity of the pharmaceutical or take other action.

In an embodiment of the invention, the administrator database 18 receives information relating to the item together with the indicia and compares this information with that in the manufacturer database and associated with the indicia. The control module then performs an analysis of the authenticity of the item and provides a score relating to the authenticity to the purchaser.

In the clothing industry, the indicia may be submitted to the administrator database 18 together with further information relating to the item of clothing or adornment. Examples of the further information include a three dimensional measurement or image of the clothing and/or adornment, a fabric characteristic or packaging characteristic or combination thereof.

The material or packaging characteristic may be colour, molecular structure, fixative type, number of fixatives and/or position of fixative. The fixative may one or more stitching, button, pin, zipper, hook and loop fastener, drawstring, clasp end/or a buckle. The position of the fixatives may provide a unique appearance for the article of clothing which could be used as the indicia.

The indicia may include or point to one or more of the following information as stored in the manufacturer database 16: a serial number to the clothing to which the indicia is affixed; a size of the clothing; manufacturing data; distribution data; prior query information; an image of the clothing; and/or clothing details.

The size may comprise further sizing information such as the corresponding sizes in sizing systems used in different countries and/or regions.

The manufacturing data may include time, date and location of manufacture. In the instance of hand made clothing the manufacturing data may include information regarding the actual person or persons who made the article of clothing.

The distribution data may include the location where the clothing was transited for sale, the current owner or distributor and the current and/or prior locations of the item.

The prior query information may include the time, date, content and identity or location of requestor or prior queries using the indicia.

The clothing details may include type of clothing, material, colour, collection, designer, machinist and/or studio or factory of origin. The type of clothing may include identification as shirt, blouse, pants, dress etc.

The information relating to the item may be presented together with information relating to the authentic item and associated with the indicia. In an embodiment of the invention, the information relating to the item is analysed and compared with the information relating to the authentic item. A score relating to a likelihood of authenticity of the item may be automatically produced.

In one embodiment, the indicia may be located on a consistent location of the clothing such as, where conventional labels are attached near the back of the neck when worn. According to this embodiment, when scanner 12 is incorporated on or within a mannequin or a part of a mannequin, scanner 12 may be located at a position corresponding to or allowing reading of the indicia.

In any of the embodiments described, the indicia may be encrypted. Any suitable encryption method may be used. In embodiments wherein the indicia is encrypted the indicia may include a random and a non-random portion. The non-random portion may be a distinct word such as, a brand name identifying the manufacturer, or licensed manufacturer of the goods.

The information stored in the manufacturer database 16 and/or the information dynamically updated to the administrator database 18 or a subset thereof may be provided to a customer inquiring as to the authenticity of the clothing to thereby enable a determination regarding the authenticity of the clothing.

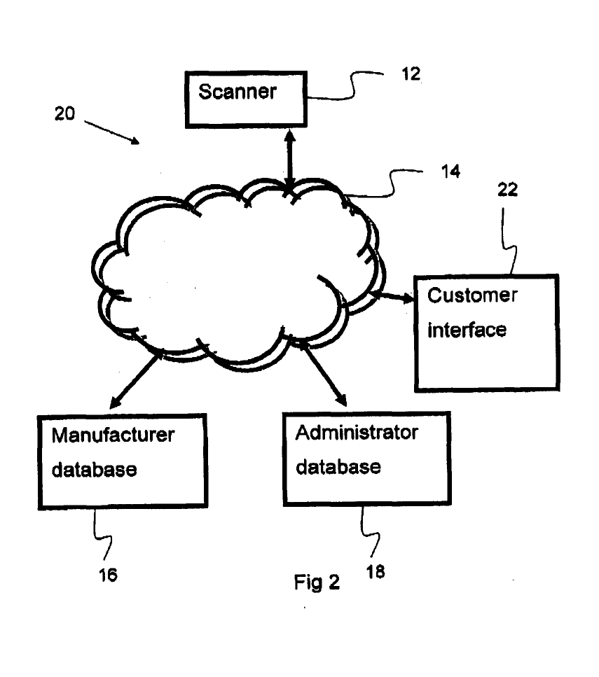

FIG. 2 shows another embodiment of a system 20 of the invention further including a customer interface 22. The customer interface may be a proprietary device provided by the operator of the system 20 to the customer or may be a customer owned device such as, a personal computer, a personal digital assistant or a smartphone. The smartphone may be a Blackberry or an iPhone.

The customer interface 22 is connected to the communications network and is able to query the administrator database 18 and/or the manufacturer database 16.

The customer interface may be used to input the indicia and or further information on the item, or capture the indicia or further information, for example through a capture device such as a camera.

In a standard retail environment such as a shopping mall, the customer may locate an item of interest. Using an authentication software application on their smartphone, the customer may scan the unique indicia of the item of interest and may receive data pertaining to the item of interest indicating that the item was last sold to the retail store in which they are viewing the item. Upon receiving the information pertaining to the item of interest, the customer is able to make their own determination regarding the likely authenticity of the item.

In other embodiments, the indicia may be formed from characteristics of an image of the item and the customer may take a picture of the item with their smartphone with this image being processed by the authentication software application. Additional information may also be requested from the customer such as the size of the item and the response may indicate a likelihood that the item is authentic with a percentage rating or some other form of graduated scale. In any event, the customer may then determine whether they are sufficiently satisfied with the response to consider the item authentic and either purchase, or decline to purchase the item.

In an online retail environment, there may be items available for sale for which a unique indicia has been provided for a batch of items. The unique indicia is presented to the online customer when viewing images of the batch of items for sale and may be captured by the online customer with a smartphone software application as described above.

However, in this embodiment, the online customer is also provided with information pertaining to the amount of stock remaining in the batch of items for sale in addition to details of the online retailer to whom the batch of goods were sold. In the event that the online customer purchases any items from the batch, the number of remaining items is decreased and this information is communicated to the manufacturer, or an authorised third party, to enable records to be updated.

In this embodiment, once an online customer receives the purchased item, they may scan the physical item and perform a second level of authenticity check. This second authenticity check is similar to the authenticity check conducted in the standard retail environment although in this instance, the information includes the address to which the goods were dispatched and provides the customer again with information pertaining to the likely authenticity of the purchased item.

Of course, if the received item is not confirmed as being genuine, then the customer would have the option of returning the goods for a full refund.

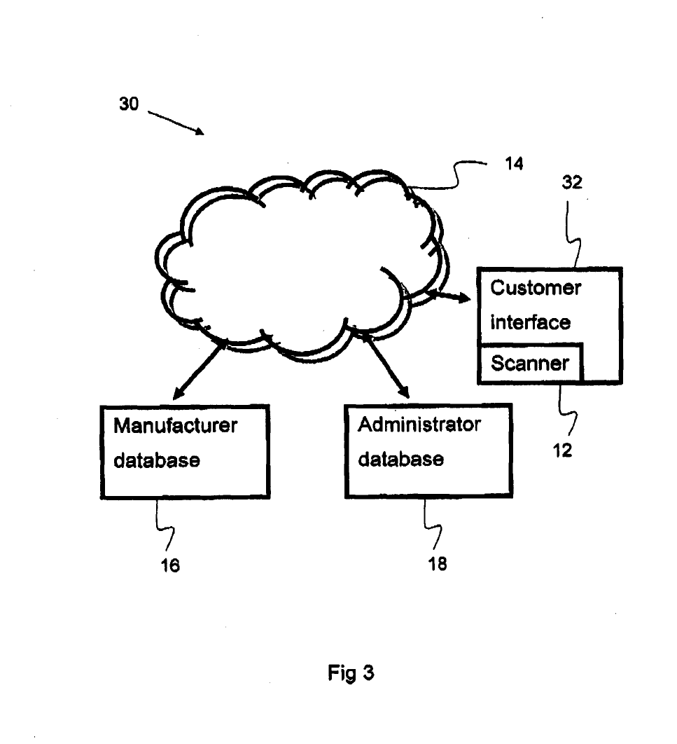

FIG. 3 shows yet another embodiment of a system according to the invention in which a capture means in the form of a scanner 12 is incorporated within the customer interface 24.

By having the customer interface 32 equipped with scanner 12, a customer may readily items to assist in assessing their authenticity. The scanner may be used to scan the item directly, or scan an image provided by a seller.

In an embodiment, the retailer updates the control module regarding the history of the item. For example, when completing the sale transaction, the retailer may obtain information from the purchaser who may be asked to complete a warranty application form or any other type of documentation that records the purchaser's details. In another embodiment, the purchaser updates the control module identifying themselves as the new owner of the item upon entering information pertaining to the receipt issued by the retailer who sold the item to them.

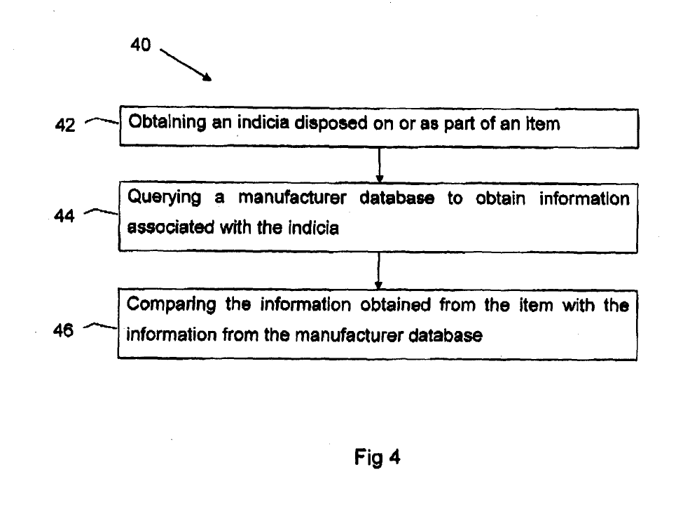

FIG. 4 is a diagrammatic representation of a method 40 according to an embodiment for aiding in the determination of the authenticity of an item by providing a customer with information relating to the likelihood that the item is an authentic item.

At step 42, the method includes obtaining an indicia disposed on, or as part of the item. Further information relating to the item may also be obtained in this step.

At step 44, the method includes querying a manufacturer database to obtain information associated with the indicia. The indicia may then be used to query a manufacturer database. The method may also include querying a control module using the indicia to obtain sale and/or inquiry history for the item.

At step 46, the method includes comparing the information obtained from the item with the information from the manufacturer database. The comparison may include comparing information of the item with the authentic item, and or for presentation of information to a prospective buyer, such that the prospective buyer may compare the information with that of the item and thereby determine the likely authenticity of the item.

Throughout the specification preferred embodiments of the invention have been described without limiting the invention to any one embodiment or specific collection of features. It will therefore be appreciated by those of skill in the art that, in view of this disclosure, various modifications and changes can be made to particular embodiments exemplified without departing from the scope and spirit of the present invention.

1. A system for assisting with the determination of the authenticity of an item when a prospective customer views an available item for purchase by providing the customer with information relating to the likely authenticity of the item, the system including:
a plurality of databases having stored therein information associated with authentic items available for purchase;
a user interface module, operable by a customer and configured to receive an indicia from a customer viewing an available item for purchase;
wherein the indicia is disposed on, or associated with, the item, and a control module, in communication with the user interface module, configured to:
receive the unique indicia and either,
retrieve data from the plurality of databases containing stored information relating to the hem, or provide a response indicating the failure to locate stored information corresponding with the supplied unique indicia; and
provide either the failure indication or the retrieved data to the user interface module for presentation to the customer
where the customer receives either a failure indication or retrieved data from the plurality of databases enabling the customer to compare same with the available item for purchase.

2. A system according to claim 1, wherein the user interface module further includes a capture module for capturing the indicia.

3. A system according to either claim 1 or claim 2, wherein the user interface module further includes receiving information relating to the item including the current and/or prior location of the item.

4. A system according to claim 3, wherein the control module generates an authenticity score based upon at least a comparison of the information from the user interface module with the information from the plurality of databases.

5. A system according to claim 4 wherein the authenticity score is presented as a colour coded guide.

6. A system according to either claim 4 or claim 5, wherein the authenticity score is presented individually for a plurality of comparison points.

7. A system according to any one of the preceding claims wherein the information presented to the customer includes a definitive view regarding the authenticity or otherwise of the item for which the indicia has been provided.

8. A system according to any one of the preceding claims, wherein the unique indicia is based upon a material characteristic including at least one of colour, molecular structure, a fixative type, number of fixatives or the position of a fixative.

9. A system according to claim 8, wherein the fixative type may include one or more of stitching, buttons, zippers, hooks and loop fasteners, drawstrings, clasps and/or buckles.

10. A system according to any one of the previous claims, wherein the indicia includes at least one of an alpha-numeric code, a bar code or a data dot.

11. A system according to any one of the previous claims, wherein the indicia is associated with at least one of a serial number; a size; manufacturing data; distribution data; a photographic image of the item; a previous location of the item, the current location of the item or a status of the item.

12. A system according to any one of the previous claims, wherein the indicia is generated from a combination of indicia and/or other information of the item.

13. A system according to any one of the preceding claims, wherein the control module includes a database that is dynamically updated with history of the item so that the history may be obtained for authentication.

14. A system according to claim 13, wherein the history of the item includes at least one of previous enquiry information, whether the item has previously been sold, a sale date of the item, previous owners of the item, or people who have worn or used the item at notable events.

15. A system according to claim 13, wherein the control module includes a fraudulent activity detector, wherein access to the stored history of the item is monitored in an attempt to locate potentially fraudulent activity on the part of entitles seeking to obtain information regarding the items for the purpose of manufacturing counterfeit copies thereof.

16. A system according to claim 13, wherein the history of the item includes whether the item is, or has been, stolen.

17. A system according to claim 13, further including an interface for receiving information relating to the sale of the item, wherein the history of the item is updated based upon receipt of information relating to sale of the item.

18. A system according to any one of the preceding claims, wherein the user interface module, the plurality of databases and the control module are operably connected to a communications network.

19. A system according to any one of the preceding claims, wherein the control module is operably connected to one or more databases for the purpose of obtaining additional information regarding the history of an item.

20. A system according to any one of the preceding claims, wherein the item may include a pharmaceutical item, an article of clothing, or an adornment.

21. A method for assisting with the determination of the authenticity of an item when a customer views an available item for purchase by providing the customer with information relating to the likely authenticity of the item, the method including;
the customer obtaining an indicia for the item that is disposed on, or associated with, the item;
querying a plurality of databases to obtain information associated with the unique indicia and receiving a response indicating either the failure to locate stored information corresponding with the supplied indicia or data containing stored information relating to the item; and
the customer comparing the received information with the available item for purchase.

22. A method according to claim 22 wherein the information associated with the unique indicia includes the current and/or prior locations of the Item.

23. Computer instruction code for assisting with the determination of the authenticity of an item that is viewed by a prospective customer as an available item for purchase by providing the customer with information relating to the likelihood that the item is authentic, including:
computer instruction code to operate a user interface module to obtain an indicia from the item that is disposed on, or associated with, the item;
computer instruction code to transmit the indicia obtained by the user interface module to a control module; and
computer instruction code operable to receive the unique indicia and either, retrieve data from a plurality of databases containing stored information relating to the item, or receive a response indicating the failure to locate stored information corresponding with the unique indicia; and
computer instruction code to present either the failure indication or the retrieved data to the customer thereby enabling the customer to compare same with the item for purchase.

24. Computer instruction code according to claim 23 wherein the stored information relating to the item includes the current and/or prior locations of the item.
